(19) United States
(12) Patent Application Publication
(10) Pub. No.: US 2006/0082701 A1
(43) Pub. Date: Apr. 20, 2006

(54) Module for liquid crystal displays

(76) Inventor: Tong Li, Plano, TX (US)

Correspondence Address: Edward Jorgenson;Philip G. Meyers Law Office, Suite 300, 1009 Long Prairie Road, Flower Mound, TX, 75022, US

(21) Appl. No.: 11/252,610

(22) Filed: Oct. 18, 2005

Related U.S. Application Data
(60) Provisional application No. 60/619,660, filed on Oct. 18, 2004.

(51) Int. Cl. G02F 1/1335

(52) U.S. Cl. 349/95

(57) ABSTRACT

A module for a liquid crystal display includes a beam divider for separating an extended light beam from the light source into discrete unpolarized micro beams, a beam displacer for separating the discrete unpolarized beams into polarized micro beams, and a color displacer for separating white polarized micro light beams from the beam displacer into orthogonally polarized primary color beams and directing the orthogonally polarized primary color to different locations for display panel.

### RELATED APPLICATION

This application claims priority from U.S. Provisional Application Ser. No. US60/619,660 filed Oct. 18, 2004, the entire contents of which is incorporated herein by reference.

### TECHNICAL FIELD

The present invention relates to liquid crystal displays and in particular to a liquid crystal display module that more efficiently utilizes the energy provided by the display backlight.

### BACKGROUND OF THE INVENTION

Liquid crystal displays (LCDs) have been widely used as display screens in portable electronics applications, such as notebook computers, camcorders, cell phones as similar devices. In LCD displays, there are two ways to show the images on the screen, either with a backlight (transmissive mode) or using ambient light (reflective mode) to illuminate the LCD panel. However, in the case of color LCD displays utilization of the photon energy of the backlight is only about 5 to 10%. Consequently, LCD screen brightness and contrast ratio are not comparable to that provided by cathode ray tubes (CRTs). Further, the power consumption of an LCD device limits the number of hours that the device may be operated on battery power. For example, in the case of a notebook computer the energy consumed by the backlight typically consumes 70% or more of the available battery power between charges.

To compensate for the relatively low screen brightness and poor contrast ratio of an LCD, the light output of the backlight has to be large. This in turn results in unutilized photon energy that generates excessive heat, which is detrimental to the life of the LCD. This is especially the case for on panel devices such as thin film transistors (TFTs). Increasing backlight energy utilization has been a concern of LCD manufactures and designers since the advent of LCD displays and increasing the energy efficiency of LCD displays has the potential of increasing the use of LCDs in electronic devices.

The present invention addresses the shortcomings of conventional LCD displays by enhancing utilization of backlight energy in liquid crystal flat panel displays. Specifically, the invention increases screen brightness and contrast ratio and/or reduces energy consumption in liquid crystal displays.

### SUMMARY OF THE INVENTION

The present invention provides a module for liquid crystal displays including a beam divider with a lens array that divides light emitted by the light source into discrete micro beams and a beam displacer that splits the discrete micro beams into spaced apart polarized o and e beams. In one variation, the beam divider comprises a lens array including a transparent glass or plastic panel with first convex protrusions or lenses with a first radius on a first side and second convex protrusions or lenses with a second radius on a second side. The first radius is larger than the second radius such that light impinging the first side is transmitted from the second side as a plurality of parallel discrete light beams. In an alternate variation, the beam divider includes a first panel comprising a first transparent convex lens array and a second transparent panel comprising a second convex lens array. In this variation, the lenses of the second convex lens array have a radius smaller that the radius of the lenses of the first lens array such that light impinging the first panel is emitted from the second panel as a plurality of discrete unpolarized light beams. The lenses of the first array are aligned with the lenses of the second array with the focal points of the lenses of the first array overlapping the focal points of the lenses of the second array to produce the micro beams.

In one embodiment, the module includes a color displacer for separating white light into the primary colors red, green and blue. The color displacer includes an array of transmissive color filters, as opposed to absorption dye filters. In one aspect, the primary color filters are arranged in an array wherein a first filter transmits a first primary color and reflects a second and third primary colors and a second filter reflects the second primary color and transmits the first and third primary colors. A third filter may be used, the third filter reflecting the third primary color and transmits the first and second primary colors.

The beam displacer is made of a birefringent material such that unpolarized light traveling through the beam displacer will separate or walk-off into a polarized ordinary (o) beam and a polarized extraordinary (e) beam. The beam displacer preferably comprises liquid crystal molecules disposed between a pair of substrates. The beam displacer eliminates the need for the first polarizer in a convention LCD structure. In one variation, the beam displacer is integrated with a color displacer into a color beam displacer. The color beam displacer is preferably formed from a glass or plastic substrate, a color filter array and an array of liquid crystal molecules positioned between the substrate and color filter array.

In another variation, the invention provides a beam divider consisting of a lens array that divides light emitted by the back light into unpolarized discrete micro beams, a beam displacer and an array of first and second color filters. The first filter transmits a first primary color and reflects a second and third primary colors, the second filter reflects the second primary color and transmits the first and third primary colors. Preferably, the array of color filters is aligned perpendicular to impinging polarized beams transmitted by the beam displacer.

The invention provides a module for a liquid crystal display that eliminates the need for at least one polarizer as compared to the prior art. The elimination of the polarizer results in a larger fraction of the light emitted by the LCD light source or backlight being transmitted to the display panel. The invention also provides a module for a color liquid crystal display that utilizes an array of transmissive color filters that separate and transmit color from the light source rather than filtering the light by absorption. Consequently, an even greater fraction of the light emitted by the backlight is used for display, rather than being dissipated as heat. Combining the features of a beam displacer and color displacer can theoretically increase the overall utilization of light energy emitted by the backlight by nine fold compared to conventional LC displays. Thus, the display screen performance in terms of brightness and contrast ratio can be significantly enhanced and/or the energy consumption can be significantly reduced.

### BRIEF DESCRIPTION OF THE DRAWINGS

Additional features and advantages of the present invention will become apparent from the following description of the accompanying drawings in which like numerals designate the same or like elements:

FIG. 1 is a partial cross section of a prior art liquid crystal display structure;

FIG. 2 is a schematic partial cross section of one embodiment of the liquid crystal display module according to the invention including a beam divider, beam displacer and color displacer;

FIG. 3(a) is a schematic representation illustrating a cross section of the beam divider of FIG. 2;

FIG. 3(b) is a schematic representation of an optical system representing a lens structure of the beam divider lens array of FIG. 3(a);

FIG. 4(a) is a schematic representation of an alternative, two panel beam divider structure;

FIG. 4(b) is a schematic representation of an optical system representing a lens structure of the beam divider lens array of FIG. 4(a);

FIG. 5(a) is a schematic representation of a LCD pixel;

FIG. 5(b) is a schematic representation of an LCD pixel impinged by a light beam from a beam divider according to the invention;

FIG. 6(a) is a schematic representation of a beam displacer according to the invention;

FIG. 6(b) is a partial cross section of the beam displacer of FIG. 6(a) in which nematic liquid crystals are utilized as a birefringent material;

FIG. 7(a) is a partial cross section of a color displacer panel of the invention;

FIG. 7(b) is a front view of the filter array of the color displacer panel of FIG. 7(a);

FIG. 7(c) is a schematic representation illustrating the filtering function of the color filter array of the color displacer FIG. (7a);

FIG. 8(a) is a plot showing transmission spectrum of a red color filter in which the red spectrum is transmitted, while green and blue spectra are reflected;

FIG. 8(b) is a plot showing transmission spectrum of a green filter, in which the green spectrum is reflected, while the red and blue spectra are transmitted;

FIG. 9(a) is a schematic representation of a first color filter array suitable for use in connection with the invention;

FIG. 9(b) is a schematic representation of a second color filter array suitable for use in connection with the invention;

FIG. 10 is a schematic representation of a beam displacer and color displacer structure according to the invention wherein a color displacer panel is used as a substrate for the beam displacer;

FIG. 11(a) is a schematic representation of a module utilizing a beam divider and beam displacer according to the invention;

FIG. 11(b) is a schematic representation of a variant of the module of FIG. 11(a) illustrating the beam displacer used as passive substrate of the LCD displacer panel;

FIG. 12(a) is a schematic representation of a module according to the invention wherein the dye color filters of a convention LCD structure are replaced with a discrete color displacer panel;

FIG. 12(b) is a schematic representation of a variant of the module of FIG. 12(a) illustrating the color displacer used as passive substrate of the LCD displacer panel;

FIG. 13 is a schematic representation of a module wherein a discrete beam divider, beam displacer, and color displacer panel are positioned between a backlight device and a TN-LC panel;

FIG. 14 is a schematic representation of a module in accordance with the invention wherein an integrated color beam displacer combines the functions of a beam displacer and color displacer; and

FIG. 15 is a schematic representation of a variant of the module of FIG. 14, wherein the color beam displacer is used as a substrate of the TN-LCD display panel.

### DETAILED DESCRIPTION OF THE INVENTION

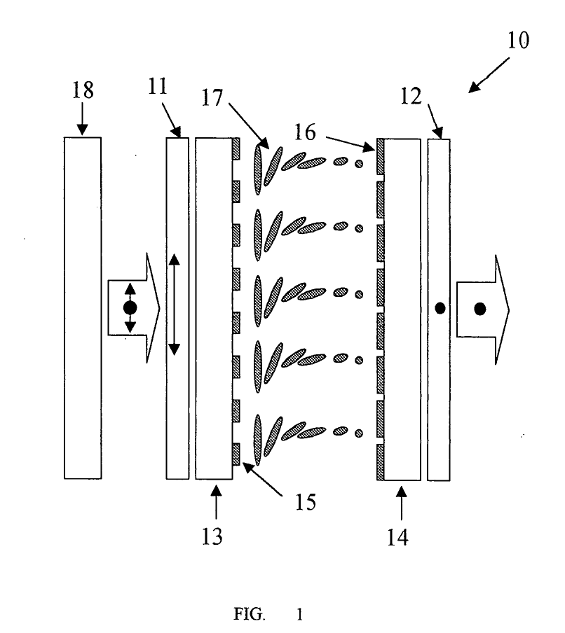

Referring to FIG. 1, a conventional simplified typical transmissive twist nematic (TN) LCD panel structure 10 comprises a pair of linear polarizers or polarizing filters 11 and 12 positioned at the entrance and exit sides of the panel, respectively. Filters 11 and 12 are oriented such that the direction of polarization of the filter 11 is orthogonal to that of filter 12. The directions of light polarization in the figures are indicated by dots and arrows. Positioned between polarizers 11 and 12 are glass substrates or plates 13 and 14. Plate 13 is the active plate on which driving devices such as thin-film transistors (TFTs) 15 are located and plate 14 is the passive plate on which dye color filters 16 are printed. Positioned between substrates 13 and 14 is a layer of twist nematic liquid crystal (TN-LC) molecules 17 that are attached to alignment layers formed on substrates 13 and 14 such that the molecules are twisted with the alignment of the ends of the molecules at each substrate surface being orthogonal to each other in the absence of an electric field. A backlighting device 18 positioned behind LCD panel 10 directs white natural (unpolarized) light onto polarizer 11. Application of an electric field realigns the TN-LC molecules to either transmit or block transmission of light.

Light from backlighting device 18 passing through filter 11 is polarized with up to about 60% of the photon energy being absorbed by the filter. Polarized light from filter 11 passes through the layer of liquid crystals molecules 17 and is filtered by dye color filter array 16 on passive plate 14 into red (R), green (G) and blue (B). Dye color filters 16 are absorption type filters which transmit light of a certain color and absorb the rest of the energy in the visible spectrum. More than 60% of the light energy that reaches color filter array 16 is absorbed. The end result is that less than 10% of the energy emitted by backlight 18 is output from panel 10. This inefficiency results in conventional LCDs having low brightness and reduced contrast ratio compared to other display devices such as cathode ray tubes (CRTs).

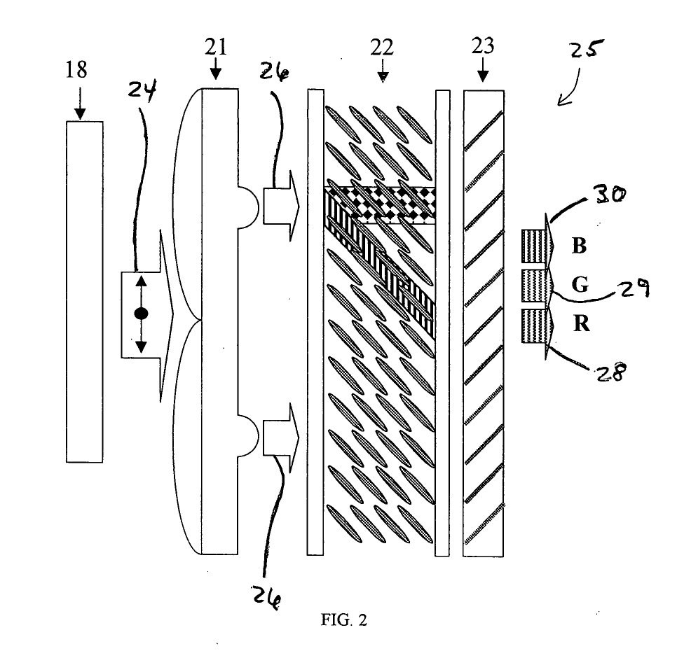

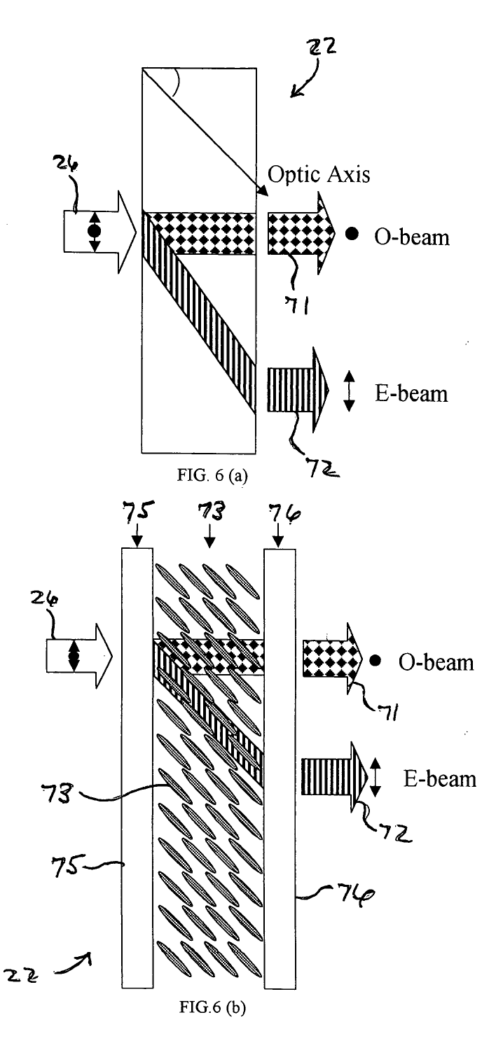

Turning to FIG. 2, a module 25 in accordance with one embodiment of the invention includes a beam divider 21, a beam displacer 22 and color displacer 23. Light 24 emitted from backlight 18 that impinges on beam divider 21 is converted to an array of discrete micro beams 26. Beam displacer 22 splits each micro beam 26 into two orthogonally polarized beams 71, 72 (FIG. 6(a)). Color displacer 23 then divides red, green and blue light from the polarized beams 71, 72, transmitting red, green and blue colored beams 28, 29 and 30. In the case of black-white LCD applications, color displacer 23 is not required and only beam divider 21 and beam displacer 22 are included in module 25.

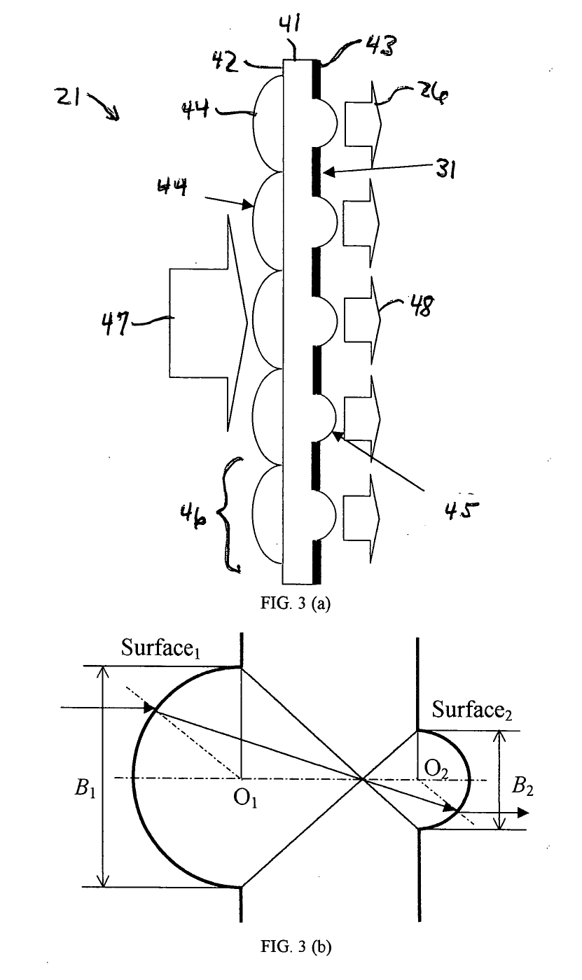

Referring now to FIGS. 2, 3(a) and 3(b), beam divider 21 comprises a transparent glass or plastic panel 41 having first and second sides 42, 43 with an array of large radius convex projections or lenses 44 on first side 42 and a plurality of smaller radius convex projections or lenses 45 on second surface 43. A black matrix 31 blocks the passage of ambient light through beam divider 21 at locations other than small radius projections 45 since undesired ambient light will result in distortion of the color transmitted through color displacer 23. The principle axis of each of large radius projections 44 is aligned with the principle axis of a small radius convex projection 45 to form a thick convex lens structure 46. As schematically illustrated in FIG. 3(b), the thickness of panel 41 and the radii of projections 44 and 45 are selected so that the focal point of each of large diameter convex projection 44 overlaps the focal point of the corresponding small radius convex projection 45.

With this structure a light beam 47 with width of B1 impinging one of large radius projections 44 with will be compressed into a micro beam 48 with width of B2 according to the magnification power of lens structure 46. The magnification power or conversion power of the beam divider is defined by the ratio of radii of convex projections 44 and 45. The width of discrete micro beams 26 (FIG. 2) and 48 should be equal to the LC panel pixel aperture width. Neglecting aperture ratio issues, for a back and white LCD the magnification power or ratio is 2:1 or 2× and for color LCD screens this ratio is 6:1 or 6× since each impinging beam width B1 must be subsequently divided to cover two or six pixels.

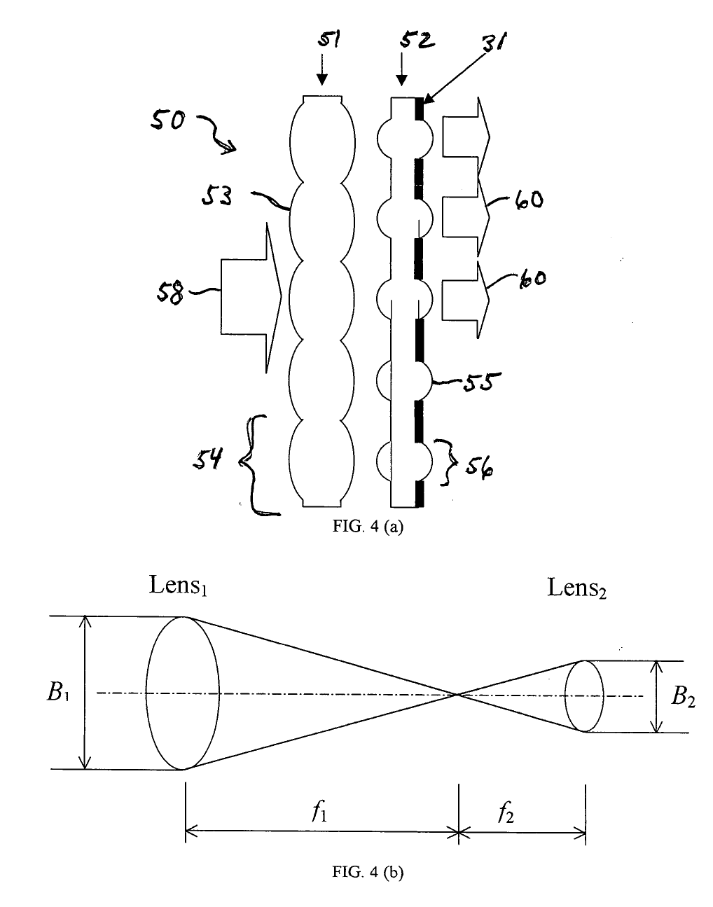

Referring to FIGS. 4(a) and 4(b), in an alternate embodiment of the invention, a beam divider 50 comprises two spaced apart transparent glass or plastic lens panels 51 and 52. Lens panel 51 includes a plurality of symmetrically arranged large radius convex projections or lenses 53 formed on both sides of the panel to form a lens structure 54. Similarly, lens panel 52 includes a plurality of small radius convex projections 55 formed on both sides of the panel to form a lens structure 56. Panels 51 and 52 are aligned and spaced such that the principle axes of lens structures 54 and 56 are aligned with overlapping focal points to form the optical system schematically illustrated in FIG. 4(b). As illustrated in FIG. 4(b), a beam of light 58 having a width of B1 impinging projection 53 will be compressed into a discrete micro beam 60 with width of B2. As will be appreciated by those skilled in the art, the working principles of the beam dividers of FIGS. 3(a) and 4(a) are essentially the same, the only difference is that in the single panel structure of FIG. 3(a) the focal points of the lens structure overlaps within the optical medium, while in two panel structure of FIG. 4(a) the focal point of the lens structure overlapped in the space between the panels. Preferably, all air-to-glass/plastic surfaces are coated with an anti-reflection agent (AR) maximize the light transmission.

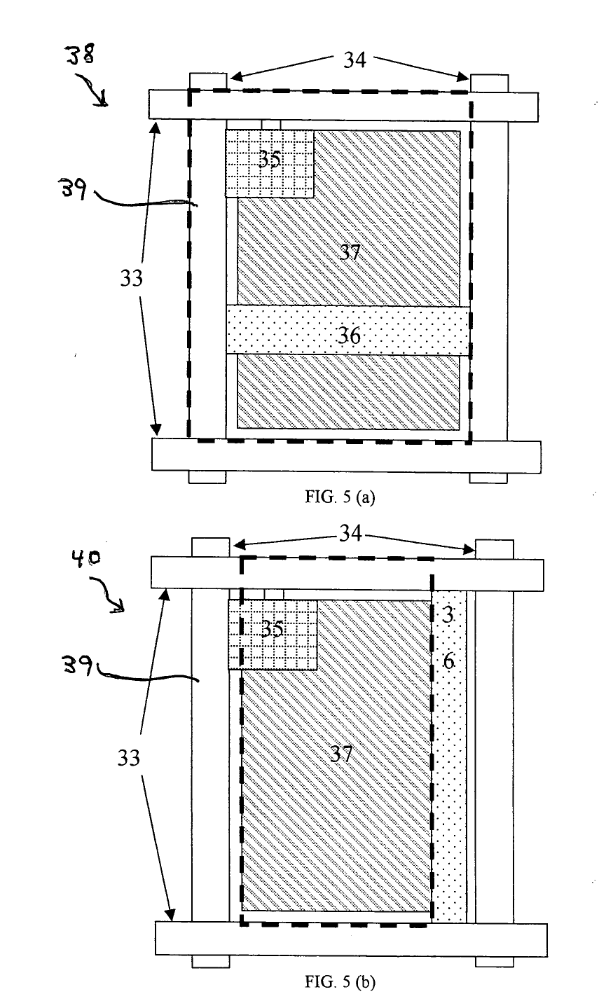

One advantage of the beam divider design of the invention is that the magnification or conversion power can be set to a desired value that permits efficient use of the light energy provided by backlight 18. For example, in a conventionally illuminated LCD structure illustrated in FIG. 5(a), not all photon energy impinging onto the pixel is utilized since the typical aperture ratio is less than 70% due to opaque areas such as the covered by storage capacitor 36 and TFT 35. Referring to FIG. 5(a), pixel cell 38 is bounded by a gate lines or row electrodes 33, data lines or column electrodes 34 and comprises a TFT 35, storage capacitor 36 and an ITO electrode 37. The aperture ratio for pixel 38 is the ratio of the transparent area within ITO electrode 37 to the illuminated area 39 encompassed by the dotted line. FIG. 5(a) schematically represents pixel 38 as illuminated by conventional means whereas FIG. 5(b) represents a similar pixel 40 illuminated in accordance with the invention. A comparison of FIG. 5(a) with FIG. 5(b) illustrates that the aperture ratio can be significantly enhanced by adjusting the beam divider's conversion or magnification power such that the illuminated area excludes or partially excludes the opaque areas of pixel cell 38.

Turning to FIGS. 6(a) and 6(b), unpolarized discrete parallel micro beams 26 transmitted from the beam splitter of FIG. 3(a) or FIG. 4(a) impinge beam displacer 22 which is made from a birefringent material. Unpolarized light traveling through beam displacer 22 will experience beam walk-off, that is, the light will be separated into a polarized ordinary (o) beam 71 and a polarized extraordinary (e) beam 72 as shown in FIG. 6(a). The walk-off angle of the crystal is determined by the crystal orientation and material birefringence. For a given walk-off angle, the walk-off distance or displacement is proportional to the crystal thickness as illustrated in FIG. 6(a). Thus, by controlling the beam displacer's thickness, the walk-off distance can be designed precisely. Ignoring aperture ratio factors for a black-white LCD structure, the thickness of beam displacer 22 is chosen such that e beam 72 is displaced from o bean 71 by a distance slightly larger than the width of beams 71, 72. In the case of a color LCD structure, beam displacer 22 needs to be thicker to assure that the displacement of e beam 72 from the o beam 71 is equal to or larger than three times the width of beams 71, 72 since each white beam will be subsequently displaced into three colored beams (red, green and blue) by color displacer 23 (FIG. 2).

Typically birefringent materials include crystals such as Calcite, YVO4 and LiNbO3. However other materials, such as liquid crystal molecules may be used to produce beam displacer 22. In the embodiment illustrated in FIG. 6(b), beam displacer 22 is formed from a spatially fixed polymer dispersed liquid crystal 73 positioned between two glass or plastic substrates 75 and 76. Preferably, the liquid crystal molecules 73 of beam displacer 22 are aligned and fixed to substrates 75 and 76 using known techniques to create the largest walk-off angle that can be realized to minimize the thickness of the beam displacer. Beam displacer 22 provides a cost effective alternative to other birefringent materials and can be fabricated in large sheet sizes. If the beam displacer panel is used as a discrete component, both outer sides of the panel are preferably coated with an anti reflection agent for maximum light transmission.

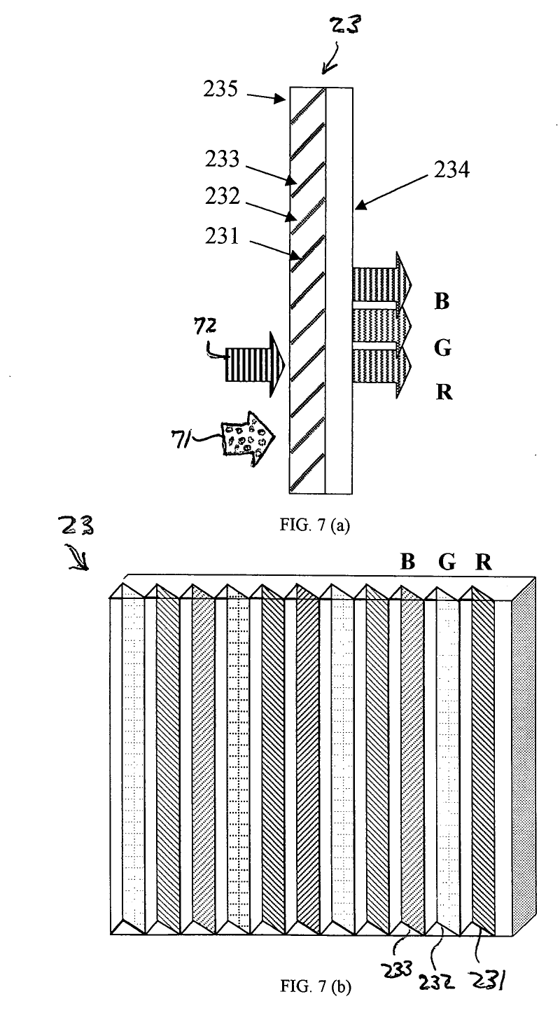

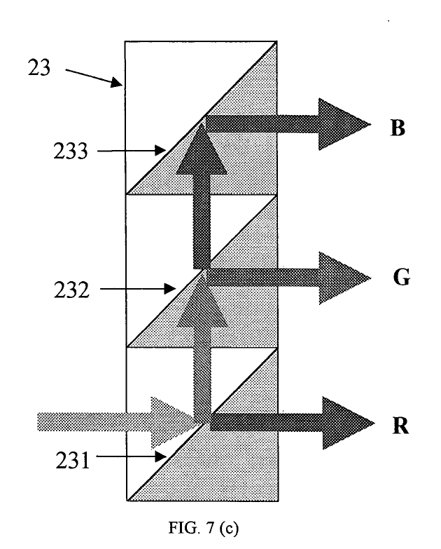

Referring to FIGS. 7(a)-7(c), polarized o and e beams, 71, 72 transmitted from beam displacer 22 impinge color displacer panel 23. Color displacer panel 23 is a cascaded beam splitter array formed from interference bandpass filters 231-233. Filters 231-233 are formed on a glass or plastic substrate 234 and set at 45 o with respect to impinging beams 71, 72. Interference filters are well known in the art and a typical dielectric interference filter is formed of alternating dielectric layers with different indices of refraction. The alternating dielectric layers can be configured in terms of thickness and high/low indices to produce a transmission window at a desired center wavelength with a desired bandwidth.

Referring to FIG. 7(c), white light impinges R filter 231 that transmits a red portion of the spectrum to active panel of the liquid crystal display and reflects the remainder of the spectrum, including green and blue spectra to G filter 232. G filter 232 reflects a green portion of the spectrum to the active panel and transmits the remainder of the spectrum to B filter 233 that reflects a blue portion of the spectrum to the active panel. In this fashion light beams of the three primary colors are sequentially displaced from white light. That is, the starting color filter 231 transmits the desired spectrum (red) to the active panel, while the next two color filters reflect the other two primary colors to the panel.

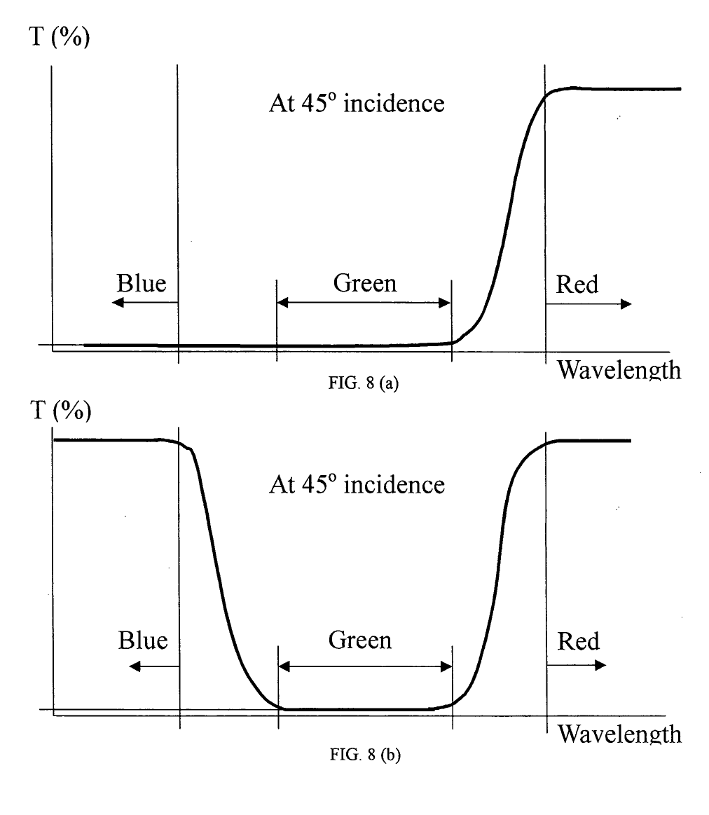

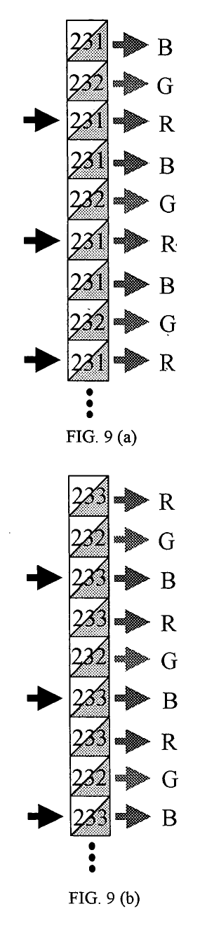

FIG. 8(a) is a plot showing transmission spectrum of R filter 231, which transmits the red portion of spectrum and reflects green and blue at 45 o. FIG. 8(b) illustrates the transmission spectrum of G filter 232 that reflects the green portion of the spectrum and transmits red and blue at 45 o. Since both filters 231 and 232 transmit red and reflect at least one of green and blue, in practice only two different filters are required to separate the three primary colors. As illustrated in FIG. 9(a), when the first filter in the array is R filter 231, the filter transmits the red portion of the spectrum to the active panel and reflects the green and blue portions. The next filter, G filter 232, reflects the green portion of the spectrum to the active panel and transmits the remaining light to the next filter in the sequence, an R filter 231 which reflects a blue portion of the spectrum panel and transmits the remainder of the light. In the same fashion, when the color string starts with blue, as illustrated in FIG. 9(b), only blue (233) and Green (232) filters may be required. The foregoing two-filter configuration for color displacer 23 simplifies and reduces the production cost of the color displacer.

As will be appreciated, proper alignment of beam divider 21 and color displacer panel 23 is important for proper functioning of the color displacer. Since the first of filters 231-233 in the color string functions as a transmissive device and the second and third filters function as reflective devices, the white light beam must be properly aligned with the first filter. If the light beam is not properly aligned with the first filter in the color string, the color composition of the light transmitted to the active panel may be wrong.

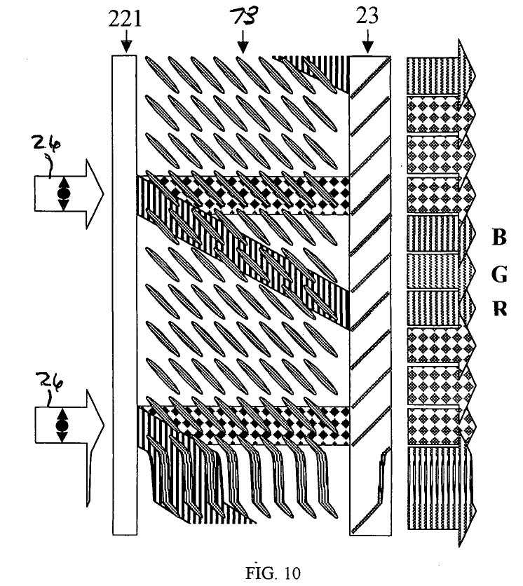

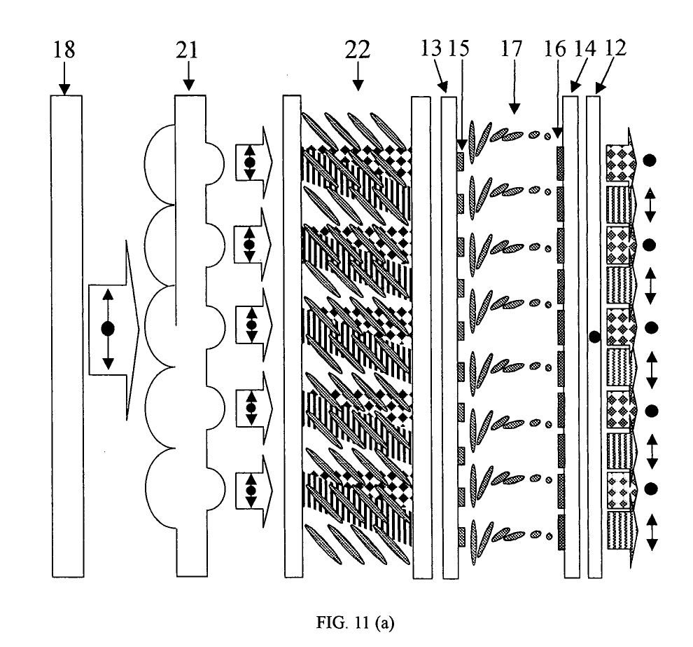

FIG. 10 illustrates another embodiment of the invention wherein the functionalities of beam displacer 22 and color displacer 23 are integrated. As shown, color displacer 23 is used as one of the substrates to sandwich spatially fixed polymer dispersed liquid crystal 73. In this configuration, the inner side of color displacer 23 does not require an anti reflective coating since the indices of the adjacent materials are very close. The configuration illustrated in FIG. 10 also eliminates the need for an anti reflective coating on the outer side of original substrate, since the function of the substrate is replaced by color displacer 23.

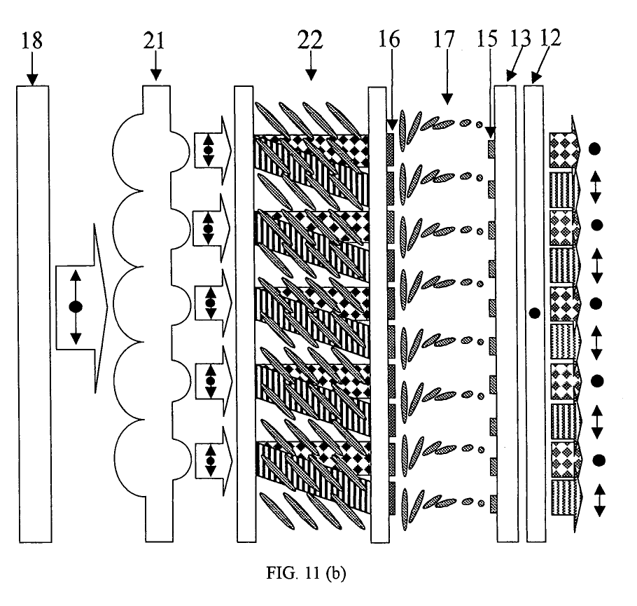

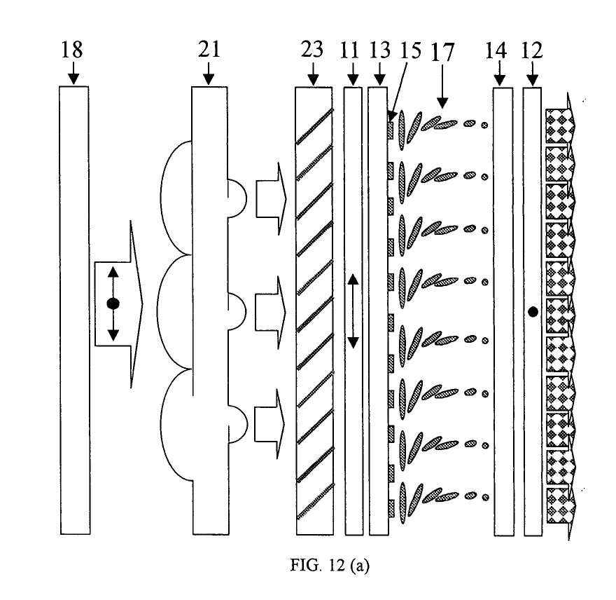

Referring to FIG. 11(a), for black and white LCD displays and color LCD displays using conventional dye color filters, beam divider 21 and beam displacer 22 can be used to replace the first linear polarizer 11 in FIG. 1. This configuration at least doubles the utilization of photon energy in LCD display. FIG. 11(a) shows the application of a combination of beam divider 21 and beam displacer 22 in conventional color LCD display. The beam from backlight 18 is divided by 2×1 beam divider panel into multiple discrete beams with their width equaling to the display pixel width. These micro beams are then displaced into alternating p- and s-beams with same width side by side, which enter the display substrate 13 and act as light sources. In this configuration, the beam divider panel 21 needs to be aligned in accordance with the pixel definition while alignment of the beam displacer 22 is not required. Since adjacent beams from the display substrate 14 are orthogonally polarized, adjacent TFTs 15 must be configured such that if a first pixel is “normally on” then the adjacent pixel must be configured to be “normally off.”

FIG. 11(b) illustrates the application in which the beam displacer 22 is used as the passive substrate 14 of the display, on which conventional dye color filter array is printed. The working principle of this configuration is identical to that in FIG. 11(a). In this configuration, two air to substrate interfaces are skipped, which implies elimination of two AR coatings and reduction of system overall thickness.

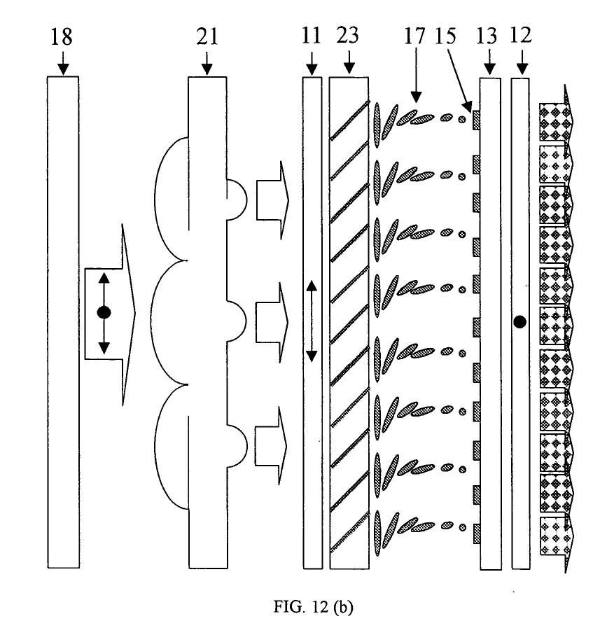

FIG. 12(a) shows a configuration wherein a module in accordance with the invention includes a discrete color displacer panel 23 eliminating the need for the dye color filters 16 of FIG. 1. In this configuration, the beam divider 21 and color displacer panel 23 are sandwiched between backlight device 18 and the TN-LC panel. The extended white beam from backlight 18 is first divided by displacer panel 21 into multiple ⅓ beams. These discrete micro white beams are then separated or displaced into three equal width primary colors beams R, G, B (red, green and blue) with color displacer 23. The colored micro beams act as light sources for the display panel. In this embodiment, first linear polarizer 11 may theoretically be placed anywhere between backlighting device 18 and active plate of LC panel 13. The simplicity of the configuration shown in FIG. 12(a) results in a module highly compatible with current TFT-LCD technology, requiring few modifications to the current TFT-LD manufacturing process.

FIG. 12(b) illustrates a TN-LC panel utilizing color displacer panel 23 as a passive substrate for the LC molecules. Since the color displacer 23 is a sheet of glass or plastic substrate that is not susceptible to excessive mechanical or thermal processes during the TFT display manufacturing process, the displacer panel may be used to support active and passive devices and to sandwich the LC molecules. For instance, for a passive plate, only two major processing steps are involved: electrode sputtering to apply the ITO electrodes and application and rubbing of the polymer molecule alignment coating. As illustrated, linear polarizer 11 is placed between beam divider 21 and color displacer 22; however, polarizer 11 may be placed anywhere between backlighting device 18 and color displacer 23. In this configuration, color displacer panel 23 needs to be properly aligned with active substrate plate 13, on which TFTs 15 are positioned. However, if the color displacer panel 23 is used as an active plate, no separate alignment process between passive and active plates 11 and 13 is required since the alignment is taken care of during TFT processing. The configuration of FIG. 12(b) simplifies manufacture of the TN-LC display structure and enhances the performance of the LCD display, due to removal of a substrate. Eliminating the substrate eliminates two AR coating processes, one on the surface of color displacer 23 and a second on the outer side of the LCD passive substrate. This configuration also reduces thickness of the display structure.

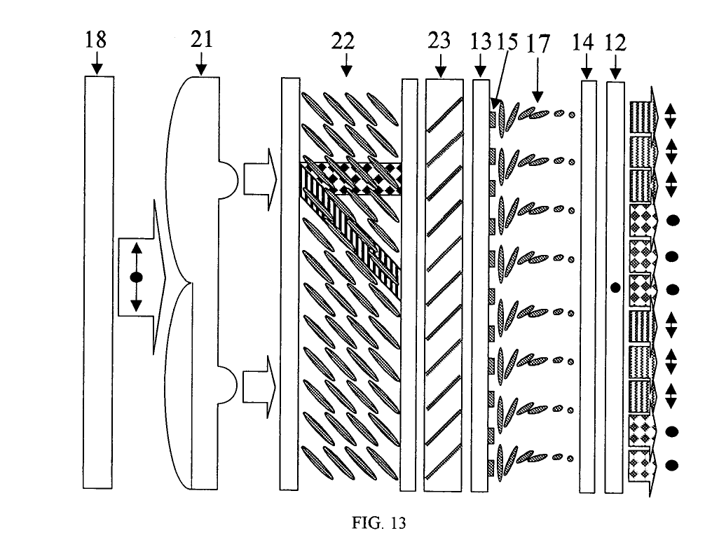

FIG. 13 illustrates the three discrete components, beam divider 21, beam displacer 22 and color displacer panel 23 positioned between backlight device 18 and the TN-LC panel. In this structure, the extended white beam from backlight 18 is first divided by 6×1 beam divider 21 into multiple ⅙ beams. The conversion or magnification power is 6×1, since the beam needs to be split into beams of p- and s-polarization by beam displacer 22 and then by color displacer 23 into the three primary colors. Beam displacer 21 splits the discrete micro beams from beam divider 21 into side-by-side p- and s-polarized beams. The polarized micro beams from beam displacer 22 then impinge color displacer 23 and are filtered into primary colors, R, G, B. The R, G, B beams then enter the display substrate 13 and act as light sources. In this configuration, p-polarized RGB beams as a unit are always adjacent to s-polarized RGB beams. Furthermore, in this configuration, the beam divider panel 21, color displacer 23 and pixel definition need to be well aligned while alignment of beam displacer 22 is not required. Since the exiting beams from the display substrate 14 are groups of orthogonally polarized RGBs, the TFT driving circuitry 15 needs to configured such that if a first three adjacent pixels are in a “normally on” mode, then the adjacent three pixel group must be “normally off” mode.

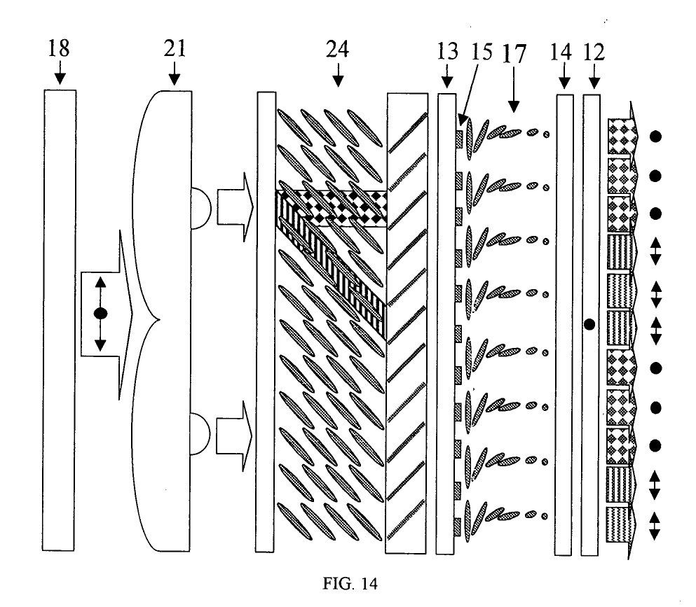

FIG. 14 illustrates the use of an integrated color beam displacer 24 that combines the functions of beam displacer 22 and color displacer 23. As shown, the color beam displacer 24 is positioned between backlighting device 18 and the TN-LC panel. In this configuration two air-to-substrate surfaces are eliminated, and hence two AR coating processes are eliminated and structure becomes more compact.

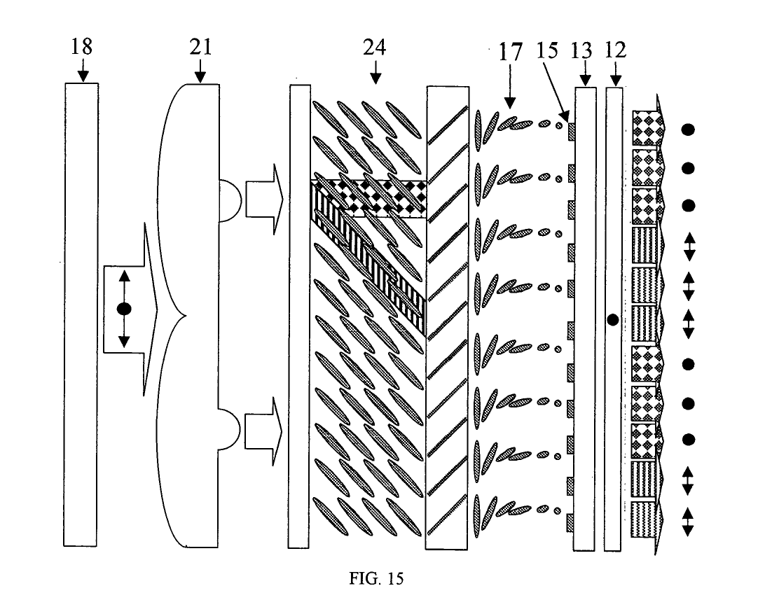

FIG. 15 shows the further integration of the system in which the integrated color beam displacer 24 acts as the passive substrate of the TN-LCD panel. The passive panel of TN-LCD illustrated in FIG. 15 requires only two processing steps, sputtering of the ITO electrode and application of the LCD polymer coating. The structure of FIG. 15 requires no complicated processes such as photolithography and dye color filter printing. Further, color beam displacer 24 is a fixed PDLC panel that is not susceptible to further processing.

The operation of the structure of FIG. 15 is the same as that of the structures of FIGS. 13 and 14. The approach illustrated in FIG. 15 further simplifies the structure and fabrication of the structure and enhances the performance of the LCD. As compared to the configuration of FIG. 14, one substrate and two AR coating processes are eliminated, one on the color displacer surface and another on the outer side of original LCD passive substrate. In addition, the thickness of the panel is reduced. As compared to the structure of FIG. 13, the configuration of FIG. 15 eliminates a beam displacer substrate and the TN-LCD panel passive substrate, the associated four interfaces and consequent processing and fabrication steps.

While certain embodiments of the invention have been illustrated for the purposes of this disclosure, numerous changes in the method and apparatus of the invention presented herein may be made by those skilled in the art, such changes being embodied within the scope and spirit of the present invention as defined in the appended claims.

1. A module for a liquid crystal display comprising:
a beam divider that converts light emitted by a backlight into unpolarized discrete micro beams.

2. The module of claim 1 wherein the beam divider comprises a lens array, the lens array including a panel having first protrusions with a first radius on a first side and second protrusions with a second radius on a second side wherein the first radius is larger than the second radius such that light impinging the first side is transmitted from the second side as a plurality of discrete light beams.

3. The module of claim 1 wherein the beam divider comprises:
a first convex lens array;
a second convex lens array, the lens of the second convex array having a radius smaller than the radius of the lenses of the first lens array, wherein light impinging the first array is transmitted from the second array as a plurality of discrete light beams.

4. The module of claim 3 wherein the first and second lens arrays comprise spaced apart transparent panels.

5. The module of claim 1 further comprising a beam displacer, the beam displacer separating the unpolarized discrete micro beams into polarized light beams

6. The module of claim 5 wherein the beam displacer comprises first and second transparent substrates with a liquid crystal array disposed between the substrates.

7. The module of claim 1 further comprising a color displacer.

8. The module of claim 7 comprising first and second primary color filters arranged in a sequential pattern to separate impinging white light into primary color beams.

9. The module of claim 7 wherein the color displacer is a filter array comprising:
a first filter that transmits a first primary color and reflects a second and third primary colors; and
a second filter that reflects the second primary color, and transmits the first and third primary colors.

10. The module of claim 9 further comprising a third filter that reflects the third primary color and transmits the first and second primary colors.

11. The module of claim 9 wherein the array of color filters is aligned perpendicular to impinging beams transmitted by the beam displacer.

12. A module for a liquid crystal display comprising:
a beam displacer, the beam displacer dividing a beam of unpolarized light into a pair of spaced apart polarized light beams.

13. The module of claim 12 wherein the beam displacer comprises first and second transparent substrates with a liquid crystal array disposed between the substrates.

14. The module of claim 12 further comprising a color displacer.

15. The module of claim 14 wherein the color displacer comprises first and second primary color filters arranged in a sequential pattern to separate impinging white light into primary color beams.

16. The module of claim 14 wherein the beam displacer and color displacer are further integrated into a color beam displacer comprising:
a substrate;
a color filter array; and
liquid crystal molecules positioned between the substrate and color filter array.

17. The module of claim 14 further comprising a beam divider, the beam divider comprising a lens array that transmits a plurality of discrete unpolarized micro beams that impinge the substrate.

18. A module for a liquid crystal display comprising:
a color displacer comprising primary color filters that separate white light into primary colors by transmission and reflection and display these colors.

19. The module of claim 18 wherein the color displacer comprises a filter array comprising:
a first filter that transmits a first primary color and reflects a second and third primary colors; and
a second filter that reflects the second primary color, and transmits the first and third primary colors.

20. The module of claim 19 further comprising a third filter that reflects the third primary color and transmits the first and second primary colors.
